(19) United States
(12) Patent Application Publication
(10) Pub. No.: US 2018/0239618 A1
(43) Pub. Date: Aug. 23, 2018

(54) PARALLEL PROCESSING DEVICE AND METHOD FOR ACTIVATING PARALLEL PROCESSING DEVICE

(71) Applicant: FUJITSU LIMITED, Kawasaki-shi (JP)

(72) Inventor: Takanori Uenaka, Numazu (JP)

(73) Assignee: FUJITSU LIMITED, Kawasaki-shi (JP)

(21) Appl. No.: 15/897,749

(22) Filed: Feb. 15, 2018

(30) Foreign Application Priority Data
Feb. 22, 2017 (JP) 2017-031050

(51) Int. Cl. G06F 9/448

(52) U.S. Cl. CPC G06F 9/4494; G06F 15/82

(57) ABSTRACT

A method for activating a parallel processing device including a plurality of computing nodes and a managing node that activates the plurality of computing nodes at multiple stages, the method includes: causing the managing node to calculate, based on measured values of inrush currents of computing nodes activated at one stage among the multiple stages, the number of computing nodes to be activated at a stage immediately succeeding the one stage, and causing the managing node to instruct to activate the number of computing nodes equal to the calculated number among the plurality of computing nodes.

### CROSS-REFERENCE TO RELATED APPLICATION

This application is based upon and claims the benefit of priority of the prior Japanese Patent Application No. 2017-31050, filed on Feb. 22, 2017, the entire contents of which are incorporated herein by reference.

### FIELD

The embodiment discussed herein is related to a parallel processing device and a method for activating a parallel processing device.

### BACKGROUND

In order to use a computer system to execute large-scale computation that is scientific computation or the like, parallel computation is executed using multiple computers. The computer system that executes the parallel computation is referred to as parallel computer system. A large-scale parallel computer system includes multiple computers for executing parallel computation and a managing computer. The managing computer manages jobs to be executed by the multiple computers. Each of the multiple computers for executing the parallel computation is referred to as computing node, while the managing computer is referred to as managing node. The parallel computer system is an example of a parallel processing device.

In addition, when power is supplied to an electronic device such as a computer, a current that has a significantly high value and is referred to as inrush current Iᵢₙ may occur immediately after the supply of the power. After that, time passes, the electronic device to which the power has been supplied becomes stable, and the current flowing in the electronic device becomes steady or becomes a steady current Iₛₜ.

If power is concurrently supplied to all the computers upon the supply of power to the parallel computer system, the total value of currents flowing in the entire parallel computer system becomes large due to inrush currents of the computers, and the amount of consumed power may exceed an upper limit defined in a contract with a power company or the like. It is, therefore, difficult to concurrently supply power to all the computers.

A technique for shifting time when power is supplied to computers and shifting time when inrush currents occur is known (for example, refer to Japanese Laid-open Patent Publications Nos. 2008-217394, 2000-207069, and 2003-99161). Due to this technique, the total value of currents flowing in the entire parallel computer system is suppressed and the amount of consumed power does not exceed the upper limit defined in the contract with the power company or the like.

Another example of related art is Japanese National Publication of International Patent Application No. 2015-503806.

When the computers are activated one by one regardless of the fact that there is a margin of the value of a current able to be supplied, a time period for activating the entire parallel computer system increases. In addition, in the case where the total value of currents flowing in the parallel computer system almost exceeds the upper limit on the value of a current able to be supplied, if the number of activated computers is not changed and an irregular current flows in the parallel computer system, the total value of the currents may exceed the upper limit.

According to an aspect, the present disclosure aims to reduce a time period for activating a parallel processing device.

### SUMMARY

According to an aspect of the invention, a method for activating a parallel processing device including a plurality of computing nodes and a managing node that activates the plurality of computing nodes at multiple stages, the method including: causing the managing node to calculate, based on measured values of inrush currents of computing nodes activated at one stage among the multiple stages, the number of computing nodes to be activated at a stage immediately succeeding the one stage, and causing the managing node to instruct to activate the number of computing nodes equal to the calculated number among the plurality of computing nodes.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram describing an inrush current and a steady current;

FIG. 2 is a diagram illustrating a configuration of a parallel computer system according to an embodiment;

FIG. 3 is a diagram describing operations of a managing node in stepwise activation;

FIG. 4 is a diagram illustrating an example of a parameter for a ratio;

FIG. 5 is a flowchart of an activation process according to the embodiment;

FIG. 6 is a diagram illustrating a configuration of an information processing device (or a computer); and

FIG. 7 is a diagram illustrating a configuration of an information processing device (or a computer).

### DESCRIPTION OF EMBODIMENT

Hereinafter, an embodiment is described with reference to the accompanying drawings. In order to supply power in a stepwise manner, the number of computing nodes to be activated at each of stages of stepwise activation is calculated. An inrush current may be theoretically calculated for a certain computing node, but there are individual differences between the values of currents that occur in computing nodes upon the activation of the computing nodes. Thus, if the numbers of computing nodes to be activated are calculated based on theoretical values, the calculated numbers of computing nodes to be activated at the stages of the stepwise activation may not be appropriate. It is desirable that the numbers of computing nodes to be activated be set to appropriate numbers by increasing the number of computing nodes if there is a margin of the value of a current to be supplied and reducing the number of computing nodes if there is not a margin of the value of a current to be supplied.

A parallel computer system tends to have a larger number of computing nodes in order to improve computation performance. It is difficult for an operator to perform an operation to efficiently activate a large number of computing nodes in a stepwise manner based on a situation.

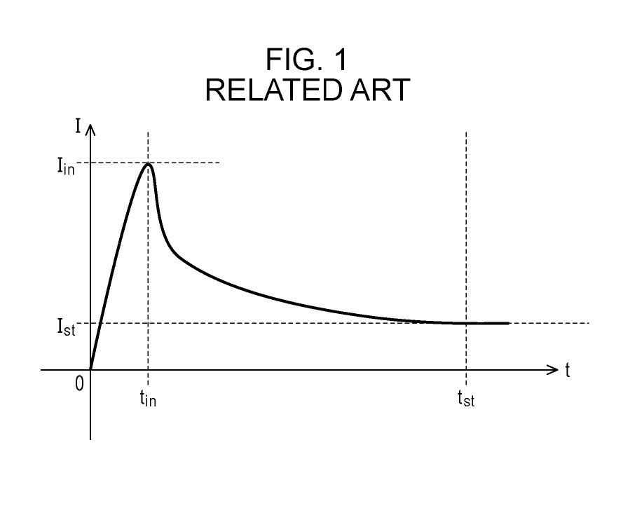

An inrush current and a steady current are described below. FIG. 1 is a diagram describing the inrush current and the steady current. A graph illustrated in FIG. 1 indicates a current that flows in a single computer upon the supply of power to the single computer. In FIG. 1, the ordinate indicates the current I, and the abscissa indicates time t.

At time t=0, power is supplied to the computer. Immediately after the supply of the power, a current that has a significantly high value and is referred to as inrush current Iᵢₙ occurs at time t=tᵢₙ. After that, time passes, the computer that is an electronic device and to which the power has been supplied becomes stable at time t=tₛₜ, and a current flowing in the computer that is the electronic device becomes steady or becomes a steady current Iₛₜ at the time t=tₛₜ.

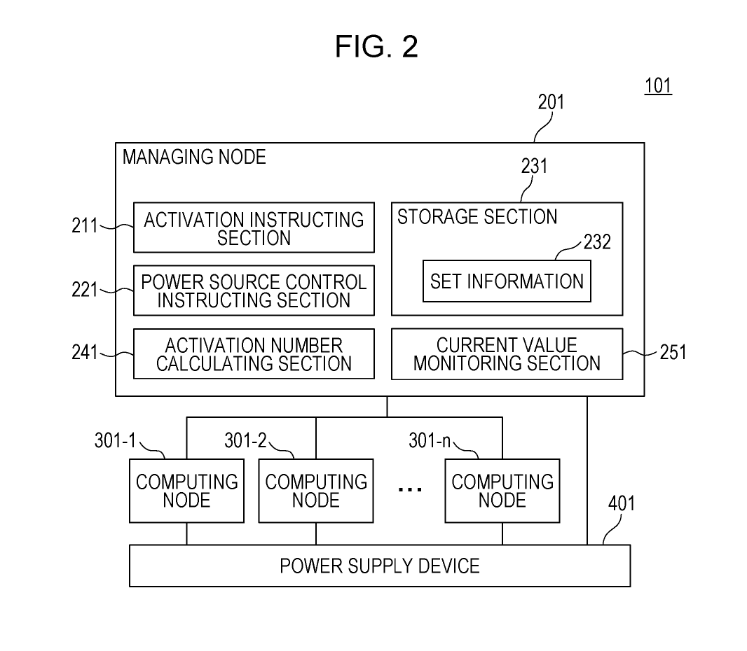

FIG. 2 is a diagram illustrating a configuration of a parallel computer system according to the embodiment. The parallel computer system 101 includes a managing node 201, computing nodes 301-i (i=1 to n), and a power supply device 401. The parallel computer system 101 is an example of a parallel processing device.

The managing node 201 controls power sources of the computing nodes 301-i. The managing node 201 activates the computing nodes 301-i in a stepwise manner. Specifically, the managing node 201 calculates the number of computing nodes 301-i to be activated at each of multiple stages of the stepwise activation and activates the number of computing nodes 301-i equal to a number calculated for each of the multiple stages at each of the multiple stages of the stepwise activation.

In addition, the managing node 201 manages jobs to be executed by the computing nodes 301-i. The managing node 201 is connected to and communicates with the computing nodes 301-i and the power supply device 401 via communication cables.

The managing node 201 includes an activation instructing section 211, a power source control instructing section 221, a storage section 231, an activation number calculating section 241, and a current value monitoring section 251. The storage section 231 stores information 232 set by a system administrator. The power source control instructing section 221 is an example of an instructing section. The activation number calculating section 241 is an example of an activation number calculating section.

The set information 232 includes a contract current value Iₘₐₓ, a margin m₁, a theoretical inrush current Iᵢₙ estimated for a single computing node 301-i, and a parameter C. The set information 232 is set by the system administrator in advance.

The contract current value Iₘₐₓ is defined in a contract with a power company and is the maximum value of a current able to be supplied by the power supply device 401.

The margin m₁ indicates a margin of the total value of currents able to be supplied to computing nodes 301-i to be activated at an initial stage of the stepwise activation and is used for the calculation of the number of computing nodes 301-i to be activated at the initial stage of the stepwise activation.

The theoretical inrush current Iᵢₙ estimated for a single computing node 301-i is presented by a manufacturing maker of the computing nodes 301-i or the like, for example.

The parameter C is a value to be used for the calculation of margins on values of currents able to be supplied to computing nodes 301-i to be activated at second and later stages of the stepwise activation.

The computing nodes 301-i are computers for executing parallel computation and are activated and stopped based on power supply control instructions received from the managing node 201. The computing nodes 301-i execute the jobs assigned by the managing node 201 and transmit the results of executing the jobs to the managing node 201. In the embodiment, the computing nodes 301-i are devices that have the same configuration. Specifically, it is assumed that theoretical values of inrush currents Iᵢₙ of the computing nodes 301-i are equal to each other.

The power supply device 401 is connected to the managing node 201 and the computing nodes 301-i via power supply cables and supplies power to the managing node 201 and the computing nodes 301-i. The power supply device 401 measures the value (system current value) of a current supplied to the parallel computer system 101 and transmits the measured system current value to the managing node 201. The system current value is the total of a measured value of a current supplied to (or flowing in) the managing node 201 and measured values of currents supplied to (or flowing in) operating computing nodes 301-i among the computing nodes 301-i.

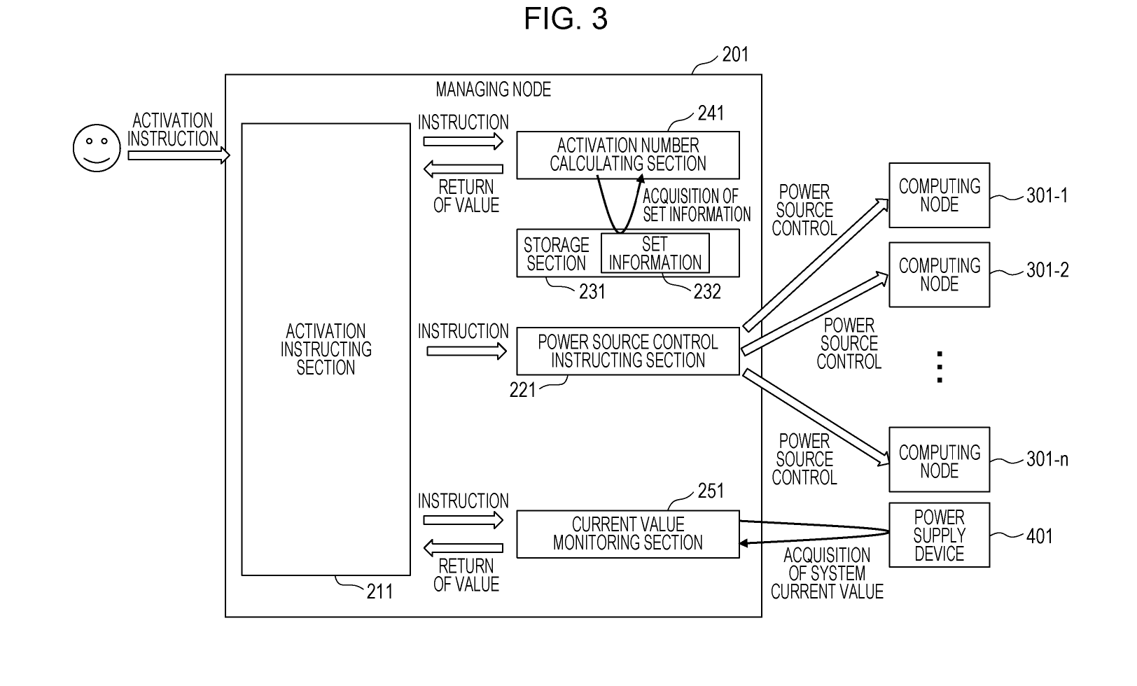

FIG. 3 is a diagram describing operations of the managing node upon the stepwise activation. It is assumed that the managing node 201 is already activated and that the computing nodes 301-i are not activated.

The activation instructing section 211 receives an activation instruction entered by the system administrator. The activation instructing section 211 instructs the activation number calculating section 241 to calculate the number of computing nodes 301-i to be activated at the initial stage of the stepwise activation.

Upon receiving the instruction, the activation number calculating section 241 reads the set information 232 and acquires the system current value Iₛₜ₀ from the power supply device 401. The activation number calculating section 241 calculates, based on the set information 232 and the system current value Iₛₜ₀, the number S₁ of computing nodes 301-i to be activated at the initial stage of the stepwise activation. The system current value Iₛₜ₀ is a steady current of the parallel computer system 101 before the initial stage of the stepwise activation. Since all the computing nodes 301-i are not activated before the initial stage of the stepwise activation, the system current value Iₛₜ₀ is a measured value of a current supplied to (or flowing in) the managing node 201 or is a measured value of a steady current of the managing node 201.

A method for calculating the number of computing nodes 301-i to be activated at the initial stage of the stepwise activation is described below.

The activation number calculating section 241 uses the following Equation (1) to calculate the number of computing nodes 301-i to be activated at the initial stage of the stepwise activation.

$${S}_{1} = floor [ \frac{( {I}_{max} - {I}_{st 0} ) \times ( 1 - \frac{{m}_{1}}{100} )}{{I}_{in}} ] \qquad ( 1 )$$

In Equation (1), floor is a function of rounding down to a whole number. The contract current value Iₘₐₓ, the margin m₁, and the theoretical inrush current Iᵢₙ estimated for a single computing node 301-i are included in the set information 232. The system current value Iₛₜ₀ is acquired from the power supply device 401. Since the system current value Iₛₜ₀ is used by the managing node 201, a value of (Iₘₐₓ−Iₛₜ₀) indicates the value of an available current able to be supplied to computing nodes 301-i to be activated at the initial stage of the stepwise activation. For example, if m₁=20, the margin m₁ indicates a margin of 20% with respect to the value of the available current to be supplied at the initial stage of the stepwise activation, (1−(m₁/100))=0.8, and a value of ((Iₘₐₓ−Iₛₜ₀)×0.8) is a target value of the total of the maximum values (inrush currents) of currents of the computing nodes 301-i to be activated at the initial stage of the stepwise activation. Thus, the number of the computing nodes 301-i to be activated at the initial stage of the stepwise activation so that the total of inrush currents of the computing nodes 301-i to be activated at the initial stage of the stepwise activation is equal to the value of ((Iₘₐₓ−Iₛₜ₀)×0.8) is obtained by dividing the target value of the total of the inrush currents of the computing nodes 301-i to be activated at the initial stage of the stepwise activation by the theoretical inrush current Iᵢₙ estimated for a single computing node 301-i.

The activation number calculating section 241 notifies the activation instructing section 211 of the calculated number S₁ of computing nodes 301-i to be activated.

The activation instructing section 211 instructs the power source instructing section 221 to activate the number of computing nodes 301-i equal to the calculated number S₁ at the initial stage of the stepwise activation.

The power source control instructing section 221 transmits an activation instruction to the number of computing nodes 301-i equal to the number S₁ among inactivated computing nodes 301-i at the initial stage of the stepwise activation. The computing nodes 301-i that have received the activation instruction start an activation process.

The current value monitoring section 251 acquires the system current value from the power supply device 401 periodically (at certain time intervals). After the activation instruction to execute the initial stage of the stepwise activation, the current value monitoring section 251 calculates the difference between the previously acquired system current value (or the system current value before a certain time interval) and the lastly acquired system current value (or the current system current value). If the calculated difference is equal to or smaller than a threshold, the current value monitoring section 251 notifies the activation instructing section 211 that the inrush currents have become steady. Specifically, the currents flowing in the computing nodes 301-i activated at the initial stage of the stepwise activation have become steady currents. The current value monitoring section 251 records the acquired system current values as history records and use the acquired system current values for the calculation of the number of computing nodes 301-i to be activated at the next stage of the stepwise activation.

Since the currents flowing in the computing nodes 301-i activated at the initial stage of the stepwise activation have become steady currents, the activation instructing section 211 starts a process of executing the second stage of the stepwise activation. The activation instructing section 211 instructs the activation number calculating section 241 to calculate the number S₂ of computing nodes 301-i to be activated at the second stage of the stepwise activation.

Upon receiving the instruction, the activation number calculating section 241 calculates the number S₂ of computing nodes 301-i to be activated at the second stage of the stepwise activation.

A method for calculating the number of computing nodes 301-i to be activated at the second stage of the stepwise activation is described below.

Since the steady currents continuously flow in the computing nodes 301-i activated in the initial stage of the stepwise activation, the total value of currents to be supplied to the computing nodes 301-i to be activated at the second stage of the stepwise activation is a value of (Iₘₐₓ−Iₛₜ₁). Iₛₜ₁ is the total value of a steady current of the managing node 201 and the steady currents of the activated computing nodes 301-i after the initial stage of the stepwise activation. Specifically, when the system current value is acquired periodically (at the certain time intervals) after the initial stage of the stepwise activation, Iₛₜ₁ indicates the lastly acquired system current value in the case where the difference between the previously acquired system current value (or the system current value before a certain time interval) and the lastly acquired system current value (or the current system current value) is equal to or smaller than the threshold.

If a margin m₂ indicating a margin of the value of a current able to be supplied to computing nodes 301-i to be activated at the second stage of the stepwise activation is considered, a target value of the total of the maximum values of currents of computing nodes 301-i to be activated at the second stage of the stepwise activation is expressed by the following Formula (2).

$$( {I}_{max} - {I}_{st 1} ) \times ( 1 - \frac{{m}_{2}}{100} ) \qquad ( 2 )$$

The margin m₂ used in the above Formula (2) is calculated based on the maximum current value Iᵢₙ₁ (or the maximum system current value after an instruction to activate computing nodes 301-i at the initial stage of the stepwise activation) upon the initial stage of the stepwise activation. The maximum current value Iᵢₙ₁ is the total of a measured value of the steady current of the managing node 201 and measured values of the inrush currents of the computing nodes 301-i activated at the initial stage of the stepwise activation. Since the current value monitoring section 251 records, as history records, system current values acquired from the power supply device 401, the maximum current value Iᵢₙ₁ is calculated from the acquired history records of the system current value.

The ratio (activation result) p₁ of the value of a current that is not used at the initial stage of the stepwise activation to the contract current value Iₘₐₓ is calculated according to the following Equation (3).

$${p}_{1} = ( 1 - \frac{{I}_{in 1} - {I}_{st 0}}{{I}_{max} - {I}_{st 0}} ) \qquad ( 3 )$$

The margin m₂ is calculated according to the following Equation (4).

$${m}_{2} = {m}_{1} + \frac{{m}_{1} - {p}_{1}}{C} \qquad ( 4 )$$

The parameter C is one or more real numbers. As the value C is smaller, the previous activation result is more strongly reflected in the value of the margin to be used for the calculation of the number of computing nodes 301-i to be activated at the current stage of the stepwise activation.

When the margin m₂ is calculated by reflecting the activation result obtained at the initial stage of the stepwise activation in the margin m₂, and the number S₂ of computing nodes 301-i to be activated at the second stage of the stepwise activation is to be calculated in the same manner as the number S₁ of computing nodes 301-i to be activated at the initial stage of the stepwise activation, the number S₂ of computing nodes 301-i to be activated at the second stage of the stepwise activation is calculated according to the following Equation (5).

$${S}_{2} = floor [ \frac{( {I}_{max} - {I}_{st 1} ) \times ( 1 - \frac{{m}_{2}}{100} )}{{I}_{in}} ] \qquad ( 5 )$$

The activation number calculating section 241 notifies the activation instructing section 211 of the calculated number S₂ of computing nodes 301-i to be activated.

The activation instructing section 211 instructs the power source control instructing section 221 to activate the number of computing nodes 301-i equal to the calculated number S₂ at the second stage of the stepwise activation.

The power source control instructing section 221 transmits an activation instruction to the number of computing nodes 301-i equal to S₂ among inactivated computing nodes 301-i at the second stage of the stepwise activation. The computing nodes 301-i that have received the activation instruction start the activation process.

The current value monitoring section 251 periodically acquires the system current value from the power supply device 401. After the activation instruction to execute the second stage of the stepwise activation, the current value monitoring section 251 calculates the difference between the previously acquired system current value and the lastly acquired system current value. If the calculated difference is equal to or smaller than the threshold, the current value monitoring section 251 notifies the activation instructing section 211 that inrush currents have become steady. Specifically, the currents flowing in the computing nodes 301-i activated at the second stage of the stepwise activation have become steady currents.

Since the currents flowing in the computing nodes 301-i activated at the second stage of the stepwise activation have become steady currents, the activation instructing section 211 starts a process of executing the third stage of the stepwise activation. In the same manner, when currents flowing in computing nodes 301-i activated at the X-1-th stage of the stepwise activation become steady currents, the managing node 201 repeats a process of calculating the number S_{X} of computing nodes 301-i to be activated at the X-th stage of the stepwise activation and activating the number of computing nodes 301-i equal to the calculated number S_{X}.

The number S_{X} of computing nodes 301-i to be activated at the X-th stage of the stepwise activation is calculated according to the following Equation (6).

$${S}_{X} = floor [ \frac{( {I}_{max} - {I}_{st ( X - 1 )} ) \times ( 1 - \frac{{m}_{X}}{100} )}{{I}_{in}} ] \qquad ( 6 )$$

I_{st(X-1)} of the aforementioned Equation (6) indicates the steady current of the parallel computer system 101 after the X-1-th stage of the stepwise activation and is the system current value when the currents flowing in the computing nodes 301-i activated at the X-1-th stage of the stepwise activation become steady currents. Specifically, I_{st(X-1)} is the total of a measured value of the steady current of the managing node 201 and measured values of steady currents of activated computing nodes 301-i after the X-1-th stage of the stepwise activation.

In addition, a margin m_{X} is calculated according to the following Equation (7).

$${m}_{X} = {m}_{X - 1} + \frac{{m}_{X - 1} - {p}_{X - 1}}{C} \qquad ( 7 )$$

The ratio p_{X-1} of an available current that is not used at the X-1-th stage of the stepwise activation to the contact current value Iₘₐₓ is used for the calculation of the margin m_{X} and is calculated according to the following Equation (8).

$${p}_{X - 1} = ( 1 - \frac{{I}_{in ( X - 1 )} - {I}_{st ( X - 2 )}}{{I}_{max} - {I}_{st ( X - 2 )}} ) \qquad ( 8 )$$

I_{in(X-1)} is the maximum current value (or the maximum system current value after the instruction to activate the computing nodes 301-i at the X-1-th stage of the stepwise activation) upon the X-1-th stage of the stepwise activation. Specifically, I_{in(X-1)} is the total of a measured value of the steady current of the managing node 201, measured values of steady currents of computing nodes 301-i activated at stages of the stepwise activation executed before the X-1-th stage of the stepwise activation, and measured values of inrush currents of the computing nodes 301-i activated at the X-1-th stage of the stepwise activation.

I_{st(X-2)} indicates the steady current of the parallel computer system 101 after the X-2-th stage of the stepwise activation. Specifically, I_{st(X-2)} is the total of a measured value of the steady current of the managing node 201 and measured values of steady currents of activated computing nodes 301-i after the X-2-th stage of the stepwise activation.

In this manner, the managing node 201 executes the process of activating the number of computing nodes 301-i equal to S₁ at the initial stage pf the stepwise activation, activating the number of computing nodes 301-i equal to S₂ at the second stage of the stepwise activation, and repeatedly activating the number of computing nodes 301-i equal to S_{X} at the X-th stage of the stepwise activation until all the computing nodes 301-i are activated.

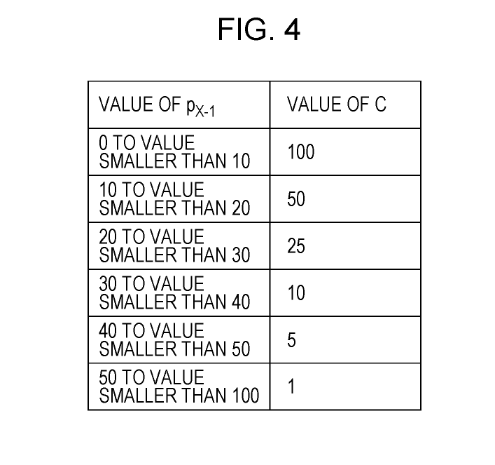

The parameter C used to calculate the margin m_{X} in the aforementioned Equation (7) may not be a fixed value and may be changed based on the ratio p_{X-1}. For example, as illustrated in FIG. 4, the parameter C may be based on the ratio p_{X-1}. In FIG. 4, if the ratio p_{X-1} is equal to or larger than 0 and smaller than 10, C=100. If the ratio p_{X-1} is equal to or larger than 10 and smaller than 20, C=50. If the ratio p_{X-1} is equal to or larger than 20 and smaller than 30, C=25. If the ratio p_{X-1} is equal to or larger than 30 and smaller than 40, C=10. If the ratio p_{X-1} is equal to or larger than 40 and smaller than 50, C=5.

If the ratio p_{X-1} is close to 0, the activation is efficiently executed with an allowable current amount or less, and it is considered that the number of computing nodes 301-i to be activated at the next stage of the stepwise activation may not be changed. Thus, as illustrated in FIG. 4, in the case where the parameter C is reduced as the ratio p_{X-1} is increased, the ratio p_{X-1} largely affects the calculation of the number of computing nodes 301-i to be activated at the next stage of the stepwise activation.

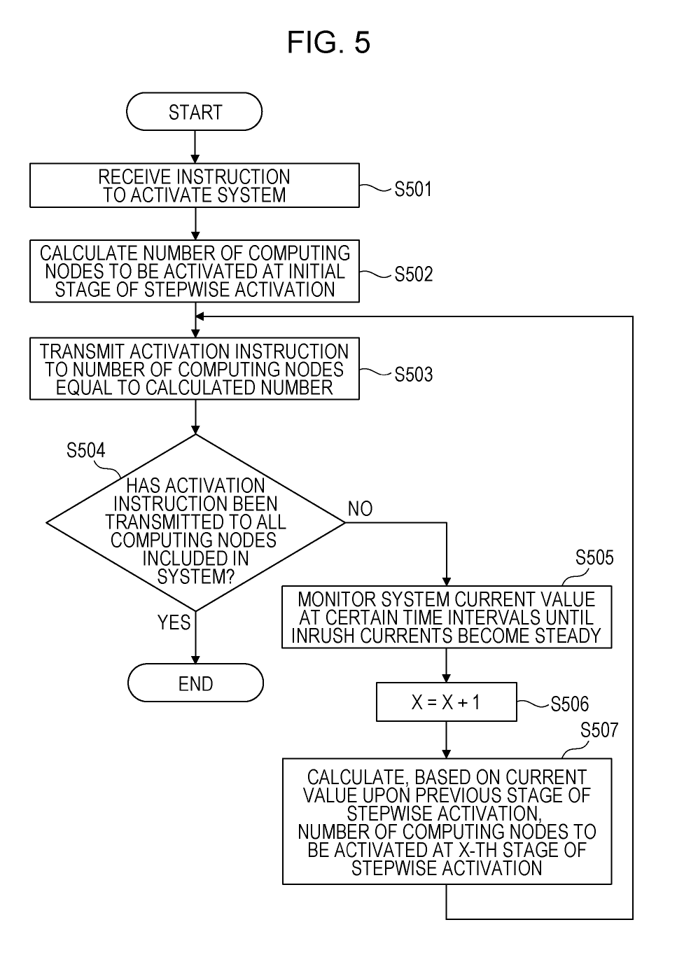

FIG. 5 is a flowchart of the activation process according to the embodiment. It is assumed that the managing node 201 is already activated and that all the computing nodes 301-i have yet to be activated.

In step S501, the activation instructing section 211 receives an activation instruction entered by the system administrator.

In step S502, the activation instructing section 211 sets, to 1, a variable X indicating the number of times when the stepwise activation is executed. The activation instructing section 211 instructs the activation number calculating section 241 to calculate the number S₁ of computing nodes 301-i to be activated at the initial stage of the stepwise activation. Upon receiving the instruction, the activation number calculating section 241 reads the set information 232 and acquires the system current value Iₛₜ₀ from the power supply device 401. The activation number calculating section 241 calculates, based on the set information 232 and the system current value Iₛₜ₀, the number S₁ of computing nodes 301-i to be activated at the initial stage of the stepwise activation. The system current value Iₛₜ₀ indicates the steady current of the parallel computer system 101 before the execution of the initial stage of the stepwise activation. Since all the computing nodes 301-i are not activated before the execution of the initial stage of the stepwise activation, the system current value Iₛₜ₀ is equal to a measured value of the steady current of the managing node 201. The activation number calculating section 241 notifies the calculated number S₁ to the activation instructing section 211.

In step S503, the power source control instructing section 221 transmits an activation instruction to the number of computing nodes 301-i equal to the calculated number S_{X} among inactivated computing nodes 301-i at the X-th stage of the stepwise activation. The computing nodes 301-i that have received the activation instruction start the activation process.

In step S504, the activation instruction section 211 determines whether or not the activation instruction has been transmitted to all the computing nodes 301-i included in the parallel computer system 101. If the activation instruction has been transmitted to all the computing nodes 301-i, the activation process is terminated. If the activation instruction has not been transmitted to one or more of the computing nodes 301-i, the activation process proceeds to step S505.

In step S505, the activation instructing section 211 instructs the current value monitoring section 251 to monitor the system current value. The current value monitoring section 251 periodically acquires the system current value from the power supply device 401 and calculates the difference between the previously acquired system current value and the lastly acquired system current value. If the calculated difference is equal to or smaller than the threshold, the current value monitoring section 251 notifies the activation instructing section 211 that inrush currents have become steady, and the activation process proceeds to step S506.

In step S506, the activation instructing section 211 increments the variable X by 1.

In step S507, the activation instructing section 211 instructs the activation number calculating section 241 to calculate the number S_{X} of computing nodes 301-i to be activated at the X-th stage of the stepwise activation. The activation number calculating section 241 calculates, based on the system current value upon the previous stage of the stepwise activation, the number S_{X} of computing nodes 301-i to be activated at the X-th stage of the stepwise activation and notifies the calculated number S_{X} to the activation instructing section 211.

In the parallel computer system 101 according to the embodiment, an activation time period to the time when all the computing nodes are activated may be reduced by dynamically changing the numbers of computing nodes to be activated at the stages of the stepwise activation.

In the parallel computer system 101 according to the embodiment, when a certain number of computing nodes are activated at a certain stage of the stepwise activation, and an available current remains, the activation time period to the time when all the computing nodes are activated may be reduced by increasing the number of computing nodes to be activated at the next stage of the stepwise activation.

In the parallel computer system 101 according to the embodiment, the numbers of computing nodes to be activated are calculated using margins, and it may be possible to inhibit the system current value from exceeding an upper limit on a current able to be supplied.

In the parallel computer system 101 according to the embodiment, a large number of computing nodes may be efficiently activated under a constraint that is the upper limit on the system current value, and a time period for activating the computing nodes is reduced. If the entire parallel computer system is maintained or the like, and all the computing nodes are stopped, the time period for activating the computing nodes is reduced after the maintenance, and a time period for restoring the parallel computer system to an operating state may be reduced. In addition, the activation process is automatically efficiently executed based on the set information without a manual operation by a person, and it may be possible to inhibit an unexpected event such as the excess of the current flowing in the system over the upper limit due to an erroneous operation.

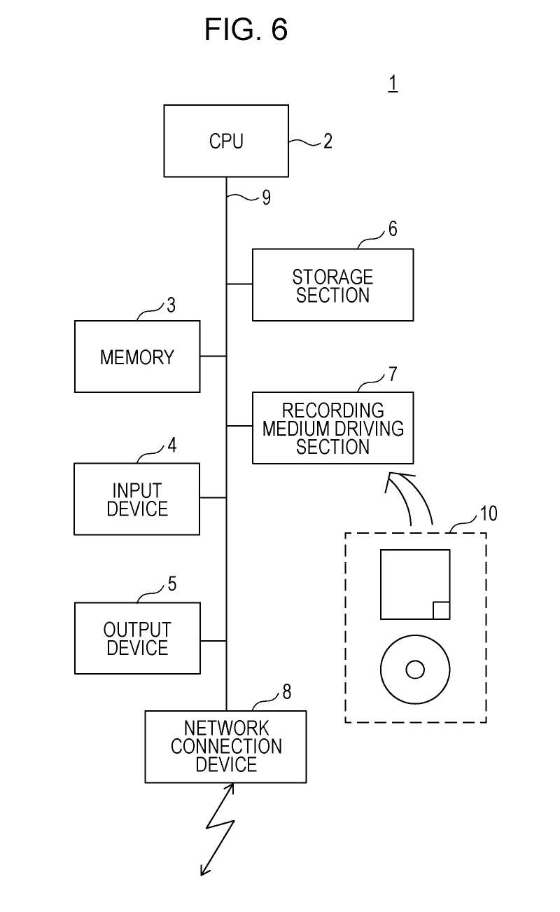

FIG. 6 is a diagram illustrating a configuration of an information processing device (or a computer).

The managing node 201 according to the embodiment may be achieved by the information processing device (or the computer) 1 illustrated in FIG. 6, for example.

The information processing device 1 includes a CPU 2, a memory 3, an input device 4, an output device 5, a storage section 6, a recording medium driving section 7, and a network connection device 8, which are connected to each other via a bus 9.

The CPU 2 operates as the activation instructing section 211, the power source control instructing section 221, the activation number calculating section 241, and the current value monitoring section 251.

The memory 3 is a read only memory (ROM), a random access memory (RAM), or the like and temporarily stores data stored in the storage section 6 (or a portable recording medium 10) or a program stored in the storage section 6 (or a portable recording medium 10) upon the execution of the program. The CPU 2 executes the program using the memory 3, thereby executing the aforementioned various processes.

In this case, codes included in the program and read from the portable recording medium 10 or the like achieve the functions described in the embodiment.

The input device 4 is used for a user or an operator to enter an instruction and information and is used to acquire data to be used by the information processing device 1. The input device 4 is, for example, a keyboard, a mouse, a touch panel, a camera, a sensor, or the like.

The output device 5 outputs process results and an inquiry to the user or the operator and is operated under control by the CPU 2. The output device 5 is, for example, a display, a printer, or the like.

The storage section 6 is, for example, a magnetic disk device, an optical disc device, a tape device, or the like. The information processing device 1 stores the aforementioned program and the aforementioned data in the storage section 6, reads the program and the data from the memory 3, and uses the program and the data. The memory 3 and the storage section 6 correspond to the storage section 231.

The recording medium driving section 7 drives the portable recording medium 10 and accesses details stored in the portable recording medium 10. As the portable medium 10, an arbitrary computer-readable recording medium such as a memory card, a flexible disk, a compact disc read only memory (CD-ROM), an optical disc, or a magneto-optical disc is used. The user stores the aforementioned program and the aforementioned data in the portable recording medium 10, reads the program and the data into the memory 3, and uses the read program and the read data.

The network connection device 8 is a communication interface that is connected to an arbitrary communication network such as a local area network (LAN) or a network conforming to InfiniBand or the like and converts data for communication. The network connection device 8 transmits data to a device connected to the information processing device 1 via the communication network or receives data from the device connected to the information processing device 1 via the communication network.

The information processing device 1 may not include all the constituent sections illustrated in FIG. 6. A part of the constituent sections may be omitted based on the use of the information processing device 1 or a condition of the information processing device 1.

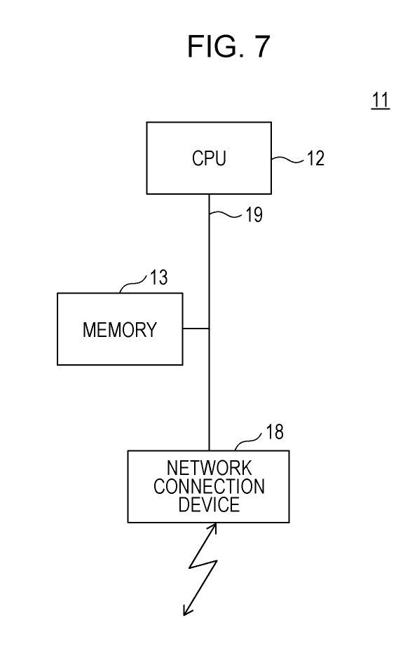

FIG. 7 is a diagram illustrating a configuration of an information processing device (or a computer).

Each of the computing nodes 301-i according to the embodiment may be achieved by the information processing device (or the computer) 11 illustrated in FIG. 7.

The information processing device 11 includes a CPU 12, a memory 13, and a network connection device 18, which are connected to each other via a bus 19.

The CPU 21 executes a program using the memory 13, thereby executing the jobs assigned by the managing node 201.

The memory 13 is a read only memory (ROM), a random access memory (RAM), or the like and temporarily stores the program or data upon the execution of the program.

The network connection device 18 is a communication interface that is connected to an arbitrary communication network such as a LAN or a network conforming to InfiniBand or the like and converts data for communication. The network connection device 18 transmits data to a device connected to the information processing device 11 via the communication network or receives data from the device connected to the information processing device 11 via the communication network.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A parallel computer system comprising:
a plurality of computing nodes; and
a managing node that activates a subset of the plurality of computing nodes at multiple activation stages,
wherein the managing node includes:
a memory, and
a processor coupled to the memory and configured to execute a process comprising:
calculating, based on measured values of inrush currents of a first subset of computing nodes activated at a first activation stage, a second subset of computing nodes to be activated at an activation stage subsequent to the first activation stage, and
activating the second subset of computing nodes at the subsequent activation stage.

2. The parallel computer system according to claim 1,
wherein in the calculating, the first subset of computing nodes to be activated at the first activation stage is calculated, based on the maximum value of a current able to be supplied to the computing nodes to be activated at the subsequent activation stage and a margin of the maximum value of the current able to be supplied to the computing nodes to be activated at the subsequent activation stage.

3. The parallel computer system according to claim 2,
wherein in the calculating, the maximum value of the current able to be supplied to the second subset of computing nodes to be activated at the subsequent activation stage is calculated by subtracting the total of measured values of steady currents of computing nodes activated before and at the first activation stage and a measured value of a steady current of the managing node from the maximum value of a current able to be supplied to the parallel computer system.

4. The parallel computer system according to claim 1,
wherein in the calculating, the first subset of computing nodes to be activated at the first activation stage is calculated based on measured values of steady currents of computing nodes activated before and at an activation stage preceding the first activation stage and a measured value of a steady current of the managing node.

5. A parallel computer system activation method comprising:
activating, using a managing node included in the parallel computer system, a subset of the plurality of computing nodes included in the parallel computer system at multiple activation periods;
calculating, using the managing node, based on measured values of inrush currents of a first subset of computing nodes activated at a first activation stage, a second subset of computing nodes to be activated at an activation stage subsequent to the first activation stage, and
activating, using the managing node, the second subset of computing nodes at the subsequent activation stage.

6. The parallel computer system activation method according to claim 5,
wherein in the calculating, the first subset of computing nodes to be activated at the first activation stage is calculated based on the maximum value of a current able to be supplied to the computing nodes to be activated at the subsequent activation stage and a margin of the maximum value of the current able to be supplied to the computing nodes to be activated at the subsequent activation stage.

7. The method according to claim 6,
wherein in the calculating, the maximum value of the current able to be supplied to the second subset of computing nodes to be activated at the subsequent activation stage is calculated by subtracting the total of measured values of steady currents of computing nodes activated before and at the first activation stage and a measured value of a steady current of the managing node from the maximum value of a current able to be supplied to the parallel computer system.

8. The method according to claim 5,
wherein in the calculating, the first subset of computing nodes to be activated at the first activation stage is calculated based on measured values of steady currents of computing nodes activated before and at an activation stage preceding the first activation stage and a measured value of a steady current of the managing node.

9. A parallel computer system comprising:
a plurality of computing nodes; and
a managing node that activates a subset of the plurality of computing nodes at multiple time periods,
wherein the managing node includes:
a memory, and
a processor coupled to the memory and configured to:
activate a subset of the plurality of computing nodes at different time periods,
calculate, based on measured values of inrush currents of a first subset of computing nodes activated at a first time period, a second subset of computing nodes to be activated at a second time period, and
activate the second subset of computing nodes at the second time period.

10. The parallel computer system according to claim 9, wherein the managing node is further configured to
calculate the first subset of computing nodes activated at the first time period based on a preset maximum current value, a system current value of the parallel computer system prior to the activation of the plurality of computing nodes, and a margin of the preset maximum current value, and
activate the first subset of computing nodes at the first time period.

11. The parallel computer system according to claim 10, wherein the measured values of inrush currents of the first subset of computing nodes are obtained by calculating a series of differences between two system current values of the parallel computer system periodically measured at subsequent time periods occurring between the first time period and the second time period.

12. The parallel computer system according to claim 11,
wherein calculating the second subset of computing nodes to be activated at the second time period occurs subsequent to when a difference between two system current values of the parallel computer system measured at subsequent time periods occurring between the first time period and the second time period becomes equal to or smaller than a threshold.

13. A parallel computer system activation method comprising:
activating, using a managing node included in the parallel computer system, a subset of the plurality of computing nodes at different time periods,
calculating, using the managing node, based on measured values of inrush currents of a first subset of computing nodes activated at a first time period, a second subset of computing nodes to be activated at a second time period, and
activating, using the managing node, the second subset of computing nodes at the second time period.

14. The parallel computer system activation method according to claim 13, further comprising
calculating the first subset of computing nodes activated at the first time period based on a preset maximum current value, a system current value of the parallel computer system prior to the activation of the plurality of computing nodes, and a margin of the preset maximum current value, and
activating the first subset of computing nodes at the first time period.

15. The parallel computer system activation method according to claim 14, wherein the measured values of inrush currents of the first subset of computing nodes are obtained by calculating a series of differences between two system current values of the parallel computer system periodically measured at subsequent time periods occurring between the first time period and the second time period.

16. The parallel computer system activation method according to claim 15,
wherein calculating the second subset of computing nodes to be activated at the second time period occurs subsequent to when a difference between two system current values of the parallel computer system measured at subsequent time periods occurring between the first time period and the second time period becomes equal to or smaller than a threshold.
